(19) United States
(12) Patent Application Publication
(10) Pub. No.: US 2010/0154574 A1
(43) Pub. Date: Jun. 24, 2010

(54) AXIAL BACKLASH-ADJUSTED TRANSMISSION ELEMENT

(76) Inventors: Hans-Juergen Oberle, Rastatt (DE); Franz Schwendemann, Ottersweier (DE)

Correspondence Address: MICHAEL J. STRIKER, 103 EAST NECK ROAD, HUNTINGTON, NY, 11743, US

(21) Appl. No.: 11/993,590

(22) PCT Filed: Aug. 14, 2006
(86) PCT No.: PCT/EP06/65248

§ 371 Date: Dec. 21, 2007

(30) Foreign Application Priority Data
Sep. 26, 2005 (DE) 10 2005 045 919.6

(51) Int. Cl. F16H 57/12

(52) U.S. Cl. 74/409

(57) ABSTRACT

The invention relates to a transmission drive unit which comprises a shaft (2) and a housing component (5), an adjusting element (4) for adjusting the axial backlash of the shaft (2) being arranged between one end of the shaft (2) and the housing component (5). The invention is characterized in that the adjusting element has a substantially cylindrical shape and can be expanded in the radial direction, when pretensioned, in order to enlarge an outer diameter, thereby allowing to exert a pretension (F_{R}) onto the shaft (2) in the axial direction (X-X).

### RELATED ART

The present invention relates to a transmission drive unit with compensation of axial play of a shaft.

To prevent or adjust the axial play of shafts in adjusting motors or transmissions, such as spindle transmissions, the axial forces that occur during operation may result in shaft play. This play should be prevented to the greatest extent possible. Prevention of axial play is preferably designed such that it continues for the duration of the service life of the component, even if wear occurs. Publication DE 101 14 453 A1 makes known, e.g., a transmission drive unit with which compensation of axial play of a shaft is attained using damping means located on the outer circumference of a pot-shaped sleeve element. The end of the shaft is positioned in the pot-shaped sleeve element.

Other known possibilities for compensating for axial play are, e.g., to provide an adjusting screw that is located coaxial with the shaft and may be adjusted until the axial play of the shaft has been eliminated. It is also known to locate compensating washers between an end of the shaft and a support component, the compensating washers being selected from a large number of compensating washers of different thicknesses, depending on the amount of axial play that the shaft has. A large number of different compensating washers must be kept on hand, however.

### ADVANTAGES OF THE INVENTION

In contrast, the inventive transmission drive unit with the features of Claim 1 has the advantage that it may provide self-adjusting compensation of axial play. The compensation of the axial play of the shaft may be ensured for the duration of the service life of the transmission drive unit, in the new state and if use-induced wear occurs. According to the present invention, therefore, a large number of compensating washers of different thicknesses need not be kept on hand, and complicated procedures to measure the axial play in order to select the correct compensating washer may be eliminated. This is attained according to the present invention by providing a compensating element for compensating for axial play, the compensating element being located between the start-up rail and a support component, e.g., a housing part, the compensating element having an essentially cylindrical shape and being expandable in the radial direction. The compensating element may therefore exert a preload force on the armature shaft in the radial direction. The essentially cylindrical compensating element is therefore located between the shaft and a housing component in such a manner that the axial direction of the shaft is perpendicular to the axial direction of the essentially cylindrical compensating element.

The subclaims show preferred refinements of the present invention.

A readjustment force of the compensating element is preferably perpendicular to an axial direction of the shaft and/or to an axial force that acts on the shaft. As a result, the axial force acting on the shaft and the readjustment force of the compensating element are prevented from affecting each other, thereby preventing the shaft from being lifted by the readjustment force of the compensating element, e.g., if no axial force acts on the shaft.

Particularly preferably, the compensating element is a spiral. The spiral is preferably made of a metal material and may be drawn together radially to be tensioned. When the spiral is tensioned, an outer diameter is reduced in particular, thereby making assembly particularly simple and easy. Once the spiral has been installed, the loaded spiral may be simply released. Due to its inherent elasticity, the spiral attempts to return to its initial, unloaded state, and its outer diameter increases. A self-adjusting compensation of axial play using the spiral is therefore made possible in a simple manner.

According to a preferred embodiment of the present invention, the spiral is formed of a flat metal band and includes at least two windings. The windings are designed such that they are in contact with each other. Friction therefore occurs between the individual windings, thereby making it possible to provide a greater radial force to the spirals.

To ensure that the spiral is positioned correctly, the spiral preferably includes an outwardly extending positioning region that bears against the support component, or the like. The positioning region of the spiral is preferably located in a recess in the support component, or it bears against a projection formed on the support component.

According to another preferred embodiment of the present invention, the compensating element is a spiral spring made of spring wire. It may be provided in a particularly easy and cost-favorable manner.

Also preferably, a stop element with a stop surface is provided, the stop element being located on a side of the compensating element directed toward the shaft. The stop surface is located at an angle not equal to 90° with a central axis of the shaft.

The compensating element is preferably a cylindrical spring made of spring wire.

Also preferably, a thrust washer is located between an end of the shaft and the compensating element. According to the present invention, by using the compensating element, a thrust washer with a predetermined thickness may be used without the need to stockpile a large number of different thrust washers so that the compensating element may compensate for axial play that may be present.

The inventive transmission drive unit is preferably an electrical machine with a transmission part located directly on the armature shaft, e.g., a wormwheel. The electrical machine is preferably designed as an electric motor and is preferably used in comfort and convenience drives of motor vehicles, such as power windows, power sunroofs, electrical seat adjusters, etc.

### DRAWING

Exemplary embodiments of the present invention are described in detail below with reference to the attached drawing.

FIG. 1 shows a schematic top view of a transmission drive unit according to a first exemplary embodiment, during assembly,

FIG. 2 shows a schematic sectional view along the line A-A in FIG. 1,

FIG. 3 shows a schematic top view of the transmission drive unit in FIG. 1, in the assembled state,

FIG. 4 shows a schematic sectional view along the line B-B in FIG. 3,

FIG. 5 shows a schematic top view of the transmission drive unit in FIG. 1, when wear occurs,

FIG. 6 shows a schematic sectional view along the line C-C in FIG. 5,

FIG. 7 shows a schematic top view of a transmission drive unit according to a second exemplary embodiment of the present invention, and

FIG. 8 shows a sectional view of a transmission drive unit according to a third exemplary embodiment of the present invention.

### DESCRIPTION OF THE EXEMPLARY EMBODIMENTS

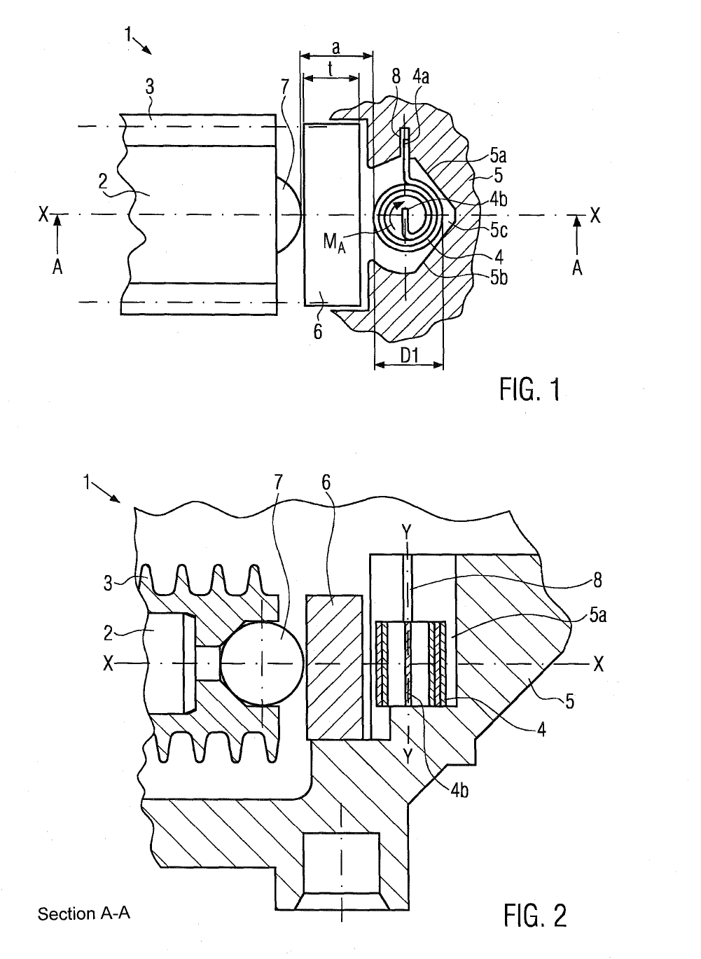

A transmission drive unit 1 according to a first exemplary embodiment of the present invention is described below with reference to FIGS. 1 through 6.

Transmission drive unit 1 includes an electric motor with a shaft 2, on which a wormwheel 3 is located. Shaft 2 is the armature shaft of the electric motor. As shown in FIG. 2 in particular, a ball 7 or a spherical axial stop that may be designed, e.g., as a cap and forms a punctiform axial bearing is located on the end of the shaft.

Shaft 2 is located in a housing component 5. In addition, a compensating element 4 is provided to compensate for axial play of shaft 2 in axial direction X-X of shaft 2. Compensating element 4 is located between a thrust washer 6 at the end of shaft 3—which is formed by ball 7 in this exemplary embodiment—and housing component 5. Housing component 5 serves as a support component for the compensating element. As shown in FIG. 1 in particular, a recess 5c with a first support surface 5a and a second support surface 5b is formed in housing component 5. First support surface 5a is perpendicular to second support surface 5b.

Compensating element 4 is a spiral made of a flat metal band. As shown in FIG. 1, compensating element 4 includes an outwardly directed positioning region 4a and an inwardly directed preload region 4b. Positioning region 4a and preload region 4b are both formed by one end of the flat band material. Compensating element 4 is essentially cylindrical in shape. Compensating element 4 is positioned relative to shaft 2 such that its axial direction Y-Y is perpendicular to axial direction X-X of the shaft (see FIG. 2).

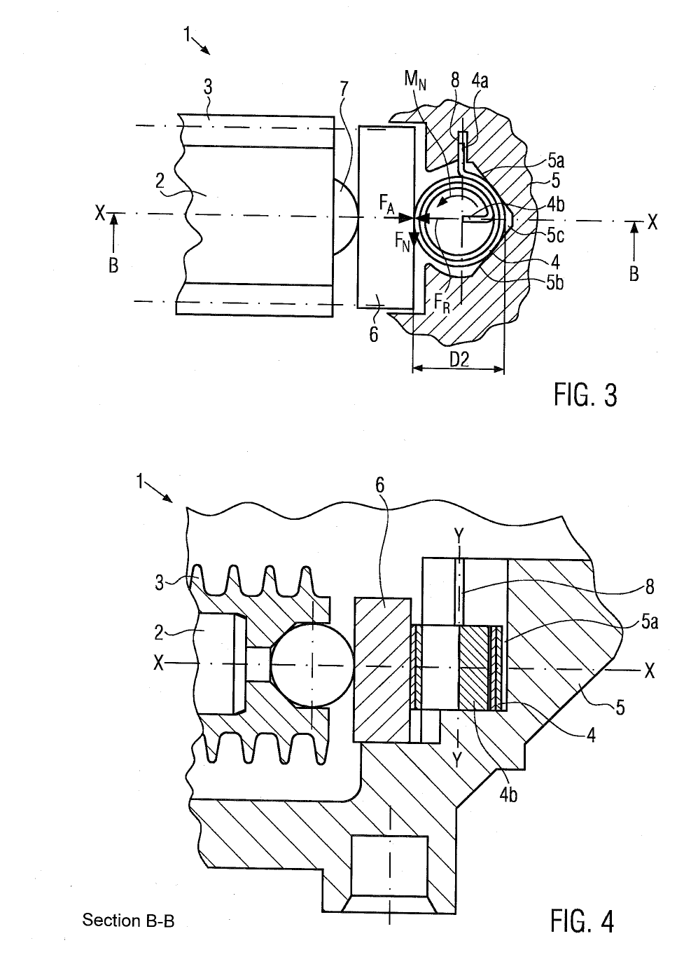

Compensating element 4 is capable of applying a radial force F_{R}, which acts in axial direction X-X of shaft 2 (see FIG. 3).

A thrust washer 6 is located between ball 7 and compensating element 4. In the installed state, thrust washer 6 is clamped between the end of shaft 2 and compensating element 4. A recess 8 is formed in housing component 5, in which positioning region 4a of compensating element 4 is located. Recess 8 therefore simplifies assembly and ensures that compensating element 4 is always positioned correctly.

FIG. 1 shows the compensating element in the assembled state. For assembly, compensating element 4 is rolled together around preload region 4b and is pretensioned, with a tightening torque M_{A} being applied to compensating element M_{A}. As shown in FIG. 1, the tightening torque is exerted in the clockwise direction. As a result, an outer diameter of compensating element 4 is reduced from a starting state, in which compensating element 4 was unloaded, to outer diameter D1. Compensating element 4 is preferably preloaded when compensating element 4 is located in housing 5, since positioning region 4a is then already located in recess 8. This simplifies the procedure for preloading the compensating element. When compensating element 4 is preloaded as shown in FIG. 1, thrust washer 6 may be easily inserted between shaft 2 and compensating element 4. It should be noted that, with regard for the assembly procedure, it is also possible to install thrust washer 6 first, of course, without compensating element 4 having been installed, and to preload compensating element 4 outside of transmission drive unit 1, so that it has a small diameter D1 and is then installed.

When all components of transmission drive unit 1 are installed, the preload is removed from compensating element 4, so that the tension on it is released. A result, a radial force F_{R} is exerted on thrust washer 6, and thrust washer 6 is pressed against ball 7 of shaft 2 (see FIG. 4). The outer diameter of compensating element 4 increases to D2, as shown in FIG. 3. As a result, compensating element 4 exerts a constant preload force on thrust washer 6 and, therefore shaft 2. Compensating element 4 bears against first and second support surfaces 5a, 5b of housing component 5. As tension is released from compensating element 4, a nominal torque M_{N} is produced, thereby causing a readjusting force F_{N} to be exerted on compensating element 4. Readjusting force F_{N} acts tangentially on the contact point between compensating element 4 and thrust washer 6. An axial force F_{A} that may act on shaft 2 is therefore perpendicular to readjusting force F_{N} (see FIG. 3). As a result, in particular, shaft 2 is prevented from being lifted due to the preload force of compensating element 4 when an axial force F_{A} is applied to compensating element 4. Compensating element 4, which is essentially cylindrical in shape, also enables installation space to be optimized, since the radial preload force is provided via a rotational motion of compensating element 4.

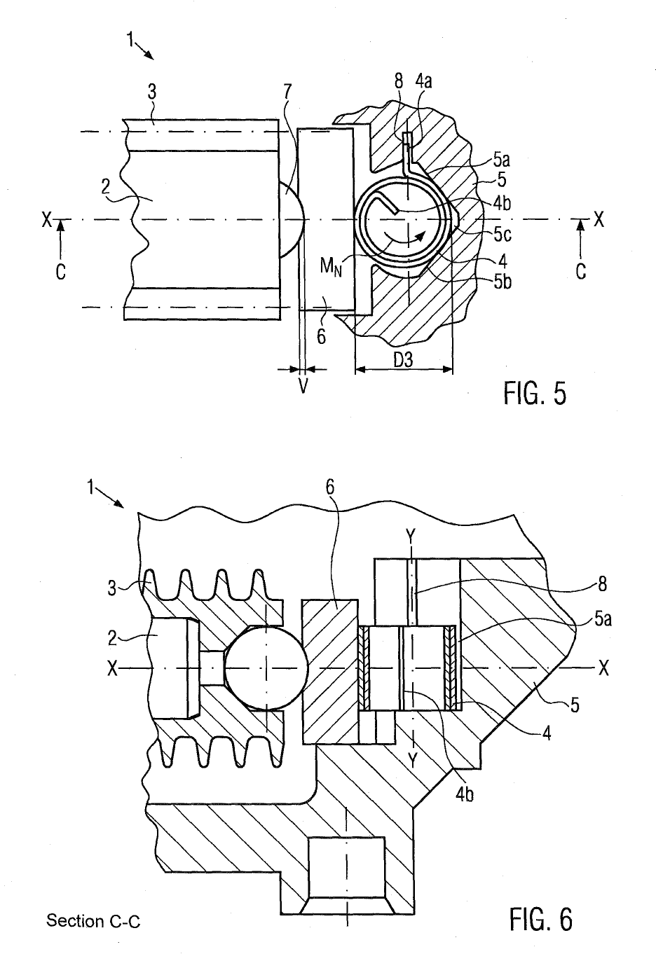

When long-term operation results in components becoming worn—which affects the axial length of the components in particular—inventive compensating element 4 may automatically compensate for the axial play. Wear V on thrust washer 6 is shown in FIGS. 5 and 6 as an example. Without inventive compensating element 4, axial play in the amount equivalent to wear V would result. Due to wear V, compensating element 4 continues it rotational motion, however, and the outer diameter of compensating element 4 increases to D3, with D3=D2+V. As a result, play is eliminated between the components in axial direction X-X of the shaft.

As revealed in a comparison of FIGS. 1, 3 and 5, compensating element 4 is therefore preloaded in the clockwise direction and relaxes in the counterclockwise direction via the increase in its diameter. This is also indicated by the respective position of preload region 4b shown in FIGS. 1, 3 and 5. The increase in the outer diameter of the compensating element always generates a radial force F_{R} that acts in direction X-X, which compensates for any play in transmission drive unit 1 that may result due to wear.

Since compensating element 4 is made of a flat material that has been rolled up, friction occurs between the individual windings that are in contact with each other, so that a sufficient amount of radial force F_{R} may be applied to shaft 2 in every position.

To ensure reliable functioning of compensating element 4 for the duration of the service life of the transmission drive unit, compensating element 4 therefore need only be preloaded in such a manner that an increase in its outer diameter may compensate for tolerances in the new state, and for the maximum wear that may occur.

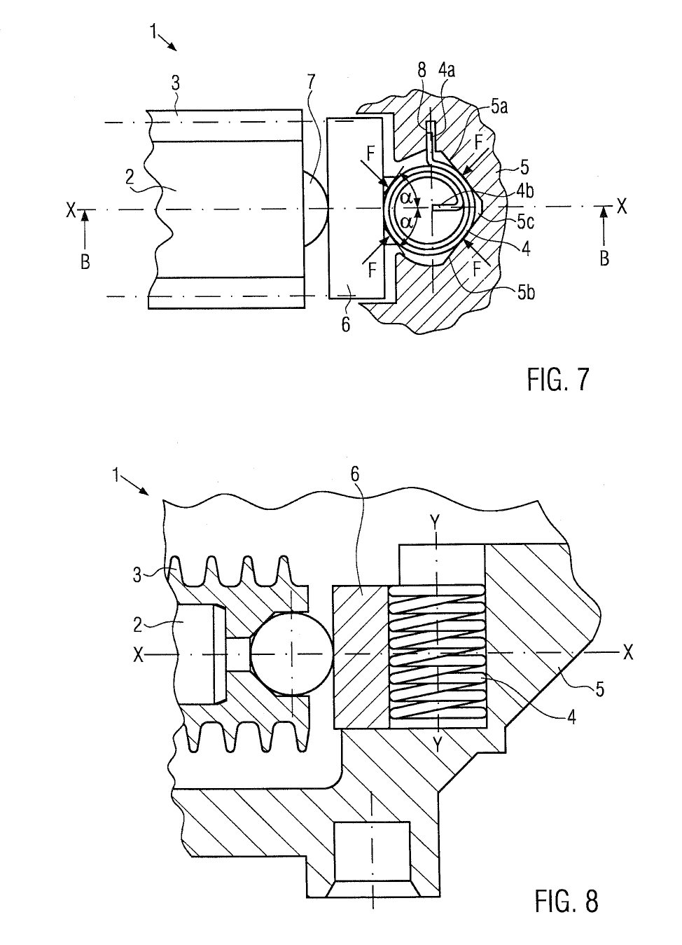

A transmission drive unit 1 according to a second exemplary embodiment of the present invention will be described below with reference to FIG. 7. Parts that are identical or that perform the same function as those in the first exemplary embodiment are labelled with the same reference numerals as in the first exemplary embodiment.

The second exemplary embodiment is essentially the same as the first exemplary embodiment, with the difference that a stop element 9 is provided. Stop element 9 includes two wedge-shaped ramps that are located on thrust washer 6. Stop element 9 includes stop surfaces 9a, which are located at an angle α to central axis X-X of shaft 2. Angle α is approximately 60°. By providing the stop element, the number of force application points—which are indicated with arrows F in FIG. 7—is increased to four. Since stop element 9 is located on thrust washer 6, it must be ensured that thrust washer 6 is installed in transmission drive unit 1 with the correct orientation.

FIG. 8 shows a transmission drive unit 1 according to a third exemplary embodiment of the present invention. Parts that are identical or that perform the same function as in the preceding exemplary embodiments are labelled with the same reference numerals as in the preceding exemplary embodiments.

The difference between the third exemplary embodiment and the first exemplary embodiment is that a cylindrical spring made of spring wire is provided as compensating element 4. As with the spiral shown in the first exemplary embodiment, the cylindrical spring may be preloaded by applying a certain amount of torque to the wire, so that an outer diameter of the cylindrical spring is reduced. The change in the outer circumference depends, in particular, on the type of wire, the number of windings, the stiffness of the wire, the thickness of the wire, etc. Compensating element 4 is installed with cylinder axis Y-Y perpendicular to axial direction X-X and is installed in the preloaded state and then released, so that a continual radial force may be applied to thrust washer 6. Otherwise, this exemplary embodiment is the same as the first exemplary embodiment, so reference is hereby made to the description provided therefor.

What is claimed is:

1. A transmission drive unit that includes a shaft (2) and a support component (5), with a compensating element (4) for compensating for axial backlash of the shaft (2) located between one end of the shaft (2) and the support component (5),
wherein
the compensating element (4) has a substantially cylindrical shape and, in the pretensioned stated, may be expanded in the radial direction in order to increase an outer diameter and exert a preload force (F_{R}) on the shaft (2) in the axial direction (X-X).

2. The transmission drive unit as recited in claim 1,
wherein
a readjustment force (F_{N}) of the compensating element (4) is perpendicular to the axial direction (X-X) of the shaft (2).

3. The transmission drive unit as recited in claim 1,
wherein
the compensating element (4) is a spiral.

4. The transmission drive unit as recited in claim 3,
wherein
the compensating element (4), which is designed as a spiral, is formed of a flat metal band or spring wire and includes at least two windings.

5. The transmission drive unit as recited in claim 4,
wherein
adjacent windings are in contact with each other.

6. The transmission drive unit as recited in claim 3,
wherein
the spiral includes an outwardly directed positioning region (4a) that bears against the support component (5).

7. The transmission drive unit as recited in claim 6,
wherein
the support component (5) includes a recess (8) or a projection against which the positioning region (4a) of the compensating element (4) bears.

8. The transmission drive unit as recited in claim 1,
wherein
the compensating element (4) is a cylindrical spring.

9. The transmission drive unit as recited in claim 1, characterized by a stop element (9) with a stop surface (9a), the stop element (9) being located on a side of the compensating element (4) directed toward the shaft (2), and the stop surface (9a) being located at an angle (α) to a central axis (X-X) of the shaft (2), the angle (α) being not equal to 90°.

10. The transmission drive unit as recited in claim 1,
wherein
a thrust washer (6) is located between an end of the shaft (2) and the compensating element (4).

11. The transmission drive unit as recited in claim 1,
wherein
a transmission component (3) is located on the shaft (2).

12. The transmission drive unit as recited in claim 1,
wherein
the shaft (2) is an armature shaft of an electric motor.
